(19) United States
(12) Patent Application Publication
(10) Pub. No.: US 2020/0189786 A1
(43) Pub. Date: Jun. 18, 2020

(54) COMPOSITE POTABLE WATER TANK AND METHOD OF FORMING

(71) Applicant: Goodrich Corporation, Charlotte, NC (US)

(72) Inventors: Aruna Kumar Huluvangala Krishnappa, Bangalore (IN); Guru Prasad Mahapatra, Bangalore (IN); Ravikumar Lachcha Nayak, Ranebennur (IN)

(21) Appl. No.: 16/509,912

(22) Filed: Jul. 12, 2019

(30) Foreign Application Priority Data
Dec. 12, 2018 (IN) 201811047034

(51) Int. Cl. B65D 1/24; B65D 25/02; B64D 11/00

(52) U.S. Cl. CPC B65D 1/24; B64D 11/00; B65D 25/02

(57) ABSTRACT

A water tank includes a compression molded tank shell. The tank shell includes a back panel and a side panel extending from the back panel. The side panel defines an outer perimeter of the water tank. A compression molded front panel is secured to the side panel to enclose an interior of the water tank. A method of forming a potable water tank includes forming a tank shell via a compression molding process, the tank shell including a back panel and a side panel extending from the back panel, the side panel defining an outer perimeter of the water tank. A front panel is separately formed by compression molding, and the front panel is secured to the side panel thereby enclosing an interior of the water tank.

### CROSS-REFERENCE TO RELATED APPLICATIONS

This application claims the benefit of Indian Application No. 201811047034 filed Dec. 12, 2018, which is incorporated herein by reference in its entirety.

### BACKGROUND

Exemplary embodiments pertain to the art of water systems. More specifically, the present disclosure relates to potable water systems utilizing conformal-shaped water storage tanks.

Many applications, such passenger aircraft, passenger trains, or the like often include potable water systems to provide water for use by passengers during operation. In an aircraft, for example, some potable water systems include a large water storage tank which is pressurized with air. The air typically is bleed air from an auxiliary power unit or is provided by a standalone air compressor for the potable water system. Aircraft operators typically desire the tank to maximize water volume storage capability, while also minimizing interior aircraft space utilized by the water storage tank. For this reason, the water storage tank is often made to an irregular or conformal shape, meant to fit in an irregular-shaped space allotted for the water storage tank at the interior of the aircraft.

### BRIEF DESCRIPTION

In one embodiment, a water tank includes a compression molded tank shell. The tank shell includes a back panel and a side panel extending from the back panel. The side panel defines an outer perimeter of the water tank. A compression molded front panel is secured to the side panel to enclose an interior of the water tank.

Additionally or alternatively, in this or other embodiments one or more baffles are positioned in the interior of the water tank.

Additionally or alternatively, in this or other embodiments the one or more baffles are secured to one of the side panel or the back panel by welding.

Additionally or alternatively, in this or other embodiments the one or more baffles are positioned in one or more slots formed in the side panel.

Additionally or alternatively, in this or other embodiments the front panel is secured to the side panel via welding.

Additionally or alternatively, in this or other embodiments one or more accessory components or fittings are secured to one or more of the side panel, the front panel or the back panel.

Additionally or alternatively, in this or other embodiments the tank shell is formed of a plurality of fibers suspended in a thermoplastic resin.

Additionally or alternatively, in this or other embodiments the plurality of fibers are carbon fibers or glass fibers.

Additionally or alternatively, in this or other embodiments the thermoplastic resin is one of polyetheretherketone (PEEK), polyaryletherketone (PAEK), or polyphenylene sulfide (PPS).

Additionally or alternatively, in this or other embodiments a liner is located in the interior of the water tank.

Additionally or alternatively, in this or other embodiments the liner is a high density polyethylene (HDPE), polyetheretherketone (PEEK) or polypropylene (PP) in the form of a powder coating, film or sheet.

In another embodiment, a method of forming a potable water tank includes forming a tank shell via a compression molding process, the tank shell including a back panel and a side panel extending from the back panel, the side panel defining an outer perimeter of the water tank. A front panel is separately formed by compression molding, and the front panel is secured to the side panel thereby enclosing an interior of the water tank.

Additionally or alternatively, in this or other embodiments one or more baffle sheets are formed and the one or more baffle sheets are installed in the interior prior to securing the front panel to the side panel.

Additionally or alternatively, in this or other embodiments the one or more baffle sheets are secured to one of the side panel or the back panel via welding.

Additionally or alternatively, in this or other embodiments the one or more baffle sheets are installed into one or more slots formed in one of the side panel or the back panel.

Additionally or alternatively, in this or other embodiments the front panel is secured to the side panel via welding.

Additionally or alternatively, in this or other embodiments one or more accessory components or fittings are secured to one or more of the side panel, the front panel or the back panel.

Additionally or alternatively, in this or other embodiments a liner is installed in the interior of the water tank prior to securing the front panel to the side panel.

Additionally or alternatively, in this or other embodiments the tank shell is formed of a plurality of fibers suspended in a thermoplastic resin.

Additionally or alternatively, in this or other embodiments the liner is a high density polyethylene (HDPE), polyetheretherketone (PEEK) or polypropylene (PP) in the form of a powder coating, film or sheet.

### BRIEF DESCRIPTION OF THE DRAWINGS

The following descriptions should not be considered limiting in any way. With reference to the accompanying drawings, like elements are numbered alike:

FIG. 1 is a perspective view of an embodiment of a water tank;

FIG. 2 is a side view of an embodiment of a water tank;

FIG. 3 is a schematic illustration of a material utilized in formation of a water tank;

FIG. 4 is schematic illustration of a baffle arrangement in a water tank;

FIG. 5 is a schematic illustration of another baffle arrangement in a water tank; and

FIG. 6 is a schematic illustration of a method of making a water tank.

### DETAILED DESCRIPTION

A detailed description of one or more embodiments of the disclosed apparatus and method are presented herein by way of exemplification and not limitation with reference to the Figures.

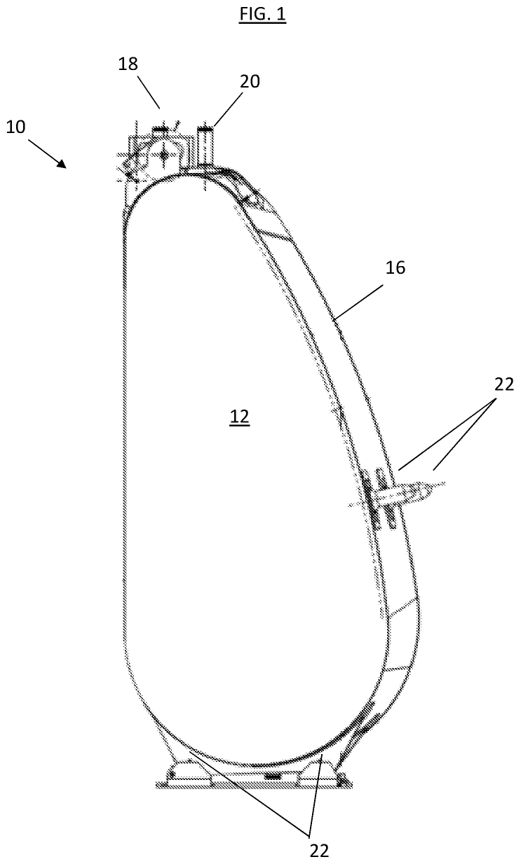

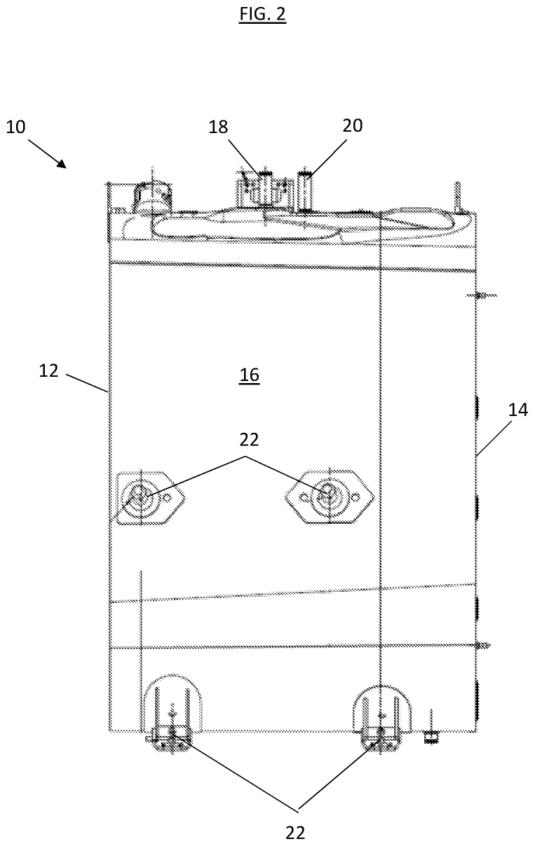

Referring to FIG. 1, shown is a schematic view of a potable water tank 10 for use in, for example, an aircraft or the like. In some embodiments, the water tank 10 is sized, for example, to hold 20 gallons of water and additional free air space. The water tank 10 includes a front wall 12, a back wall 14 (shown in FIG. 2), and a side wall 16 extending between the front wall 12 and the back wall 14. The side wall 16 defines an outer perimeter of the water tank 10. The water tank 10 has a tank inlet 18 and a tank outlet 20, which in some embodiments are accessory components attached to, for example, the side wall 16. The tank inlet 18 and the tank outlet 20 are configured to admit water to the water tank 10 and egress water from the water tank 10, respectively. Further, the water tank 10 may include one or more fittings 22 bonded or otherwise attached to the water tank 10, for example at the side wall 16.

As shown in FIGS. 1 and 2, in some embodiments the front wall 12 and the back wall 14 are flat and planar, while the side wall 16 has a curvilinear profile around the perimeter of the water tank 10.

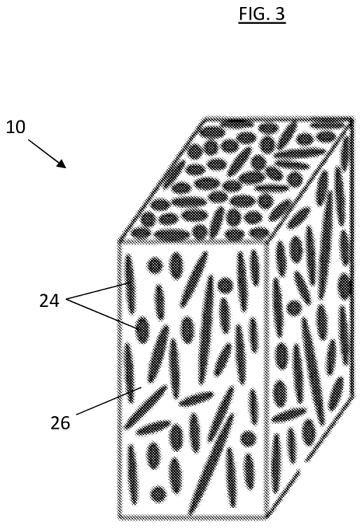

Referring now to FIG. 3, the water tank 10 is formed from a composite or molded construction of a plurality of fibers 24 suspended in a thermoplastic resin 26 formed via, for example, a compression molding process. In some embodiments, as shown in FIG. 3, the plurality of fibers 24 are oriented randomly, which enables mechanical properties of the composite part in all directions, or isotropically, similar to metal materials. In some embodiments, the plurality of fibers 24 are short or chopped carbon fiber or glass fiber. The thermoplastic resin 26 is a thermoplastic material such as polyetheretherketone (PEEK), polyaryletherketone (PAEK), or polyphenylene sulfide (PPS), for example, while other thermoplastic resin materials may be used in other embodiments. The compression molded composite structure of the water tank 10 withstands the selected hydrostatic pressure of the interior of the water tank 10, and additionally provides insulation due to the thermoplastic resin, which has low thermal conductivity.

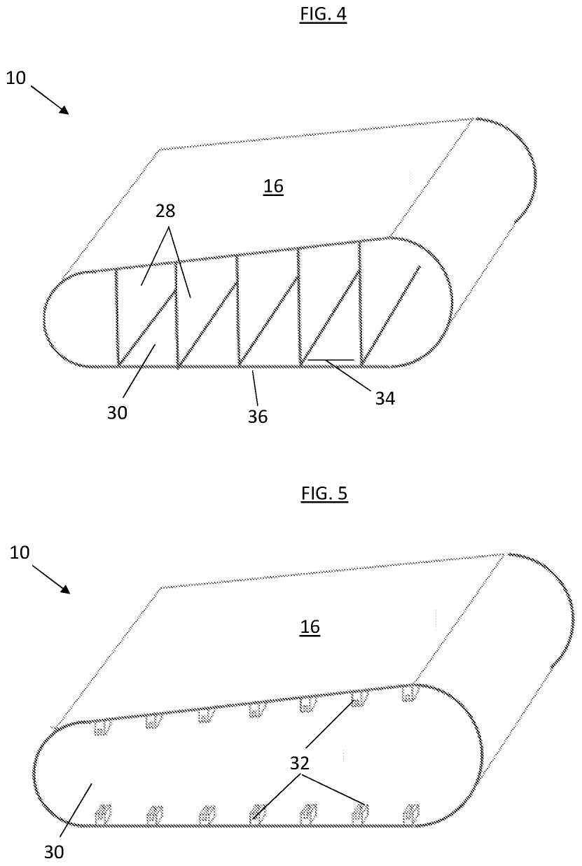

Referring now to FIG. 4, the interior 30 of the water tank 10 has one or more baffles 28 located therein. The baffles 28 extend between, for example, the front wall 12 and the back wall 14, and/or between portions of the side wall 16. In some embodiments, such as illustrated in FIG. 4, the baffles 28 are secured in the interior 30 by welding the baffles 28 to the back wall 14 and/or the side wall 16. In other embodiments, referring now to FIG. 5, mounting features 32 such as slots or brackets are formed in the side wall 16 and/or the back wall 14. The baffles 28 are installed by inserting the baffles 28 into the mounting features 32 to position and retain the baffles 28 in place in the interior 30 of the water tank 10. In some embodiments, the baffles 28 are formed from extruded sheets of thermoplastic material or thermoplastic material reinforced with short or chopped carbon fibers or glass fibers. Once the plurality of baffles 28 are installed, the front wall 12 is installed to enclose the water tank 10. The tank inlet 18, the tank outlet 20 and the one or more fittings 22 may be formed using thermoplastic based composite material and may be, for example, cocured with or welded to the water tank 10.

Referring again to FIG. 4, in some embodiments the interior 30 of the water tank 10 includes a liner 34 to prevent water leakage and compressed air leakage through the water tank 10. In some embodiments, the liner is a high density polyethylene (HDPE), polyetheretherketone (PEEK) or polypropylene (PP) in the form of a powder coating, film or sheet which may be sprayed or bonded to the interior wall 36 including the front wall 12 of the water tank 10. The liner 34 may be cured either by a localized flame spray operation or by placement into an oven at appropriate temperature. Alternatively, the film or sheet liner material 34 may be applied by a thermoforming bladder process.

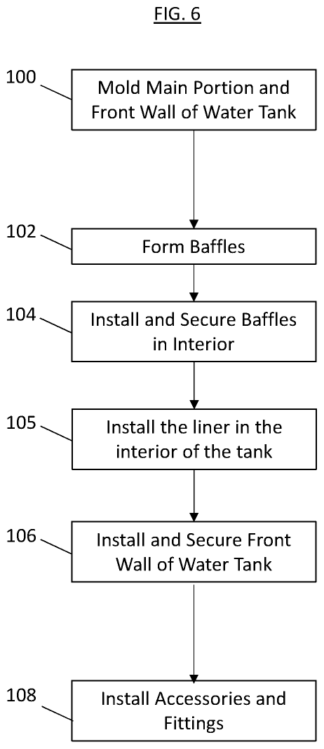

Referring now to FIG. 6, illustrated is a schematic of a method of making a fuel tank 10. Referring to block 100, a main portion of the water tank 10, including the back wall 14 and the side wall 16 is compression molded. The front wall 12 is also separately compression molded at block 100. The baffles 28 are formed at block 102, and installed into and secured in the interior 30 of the water tank 10 by welding or joining. At block 104, the liner 34 material is applied and secured to the interior 30 of the water tank 10. Also, at block 105, liner 34 material is applied on the inside of the front wall 12. At block 106, the front wall 12 is secured to the water tank 10 by, for example, welding, thus enclosing the water tank 10, and at block 108 accessories or fittings 22 are installed by, for example, co-curing or welding.

The configurations of water tank 10 disclosed herein results in a lightweight water tank 10, compared to prior art metal water tanks, due at least in part to the density of the composite material being ⅓ that of a typical metal material. The compression molded water tank 10 has improved toughness, and meets flame, smoke and toxicity requirements. The material is weldable and the process time needed to construct the water tank 10 is relatively short, in some cases compression molding process takes between 10 and 30 minutes. Due to the insulative properties of the compression molded material, the tank capacity is increased or alternatively occupies a smaller space because of the reduced insulation thickness needed.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A water tank comprising:
a compression molded tank shell, the tank shell including:
a back panel; and
a side panel extending from the back panel, the side panel defining an outer perimeter of the water tank; and
a compression molded front panel secured to the side panel to enclose an interior of the water tank.

2. The water tank of claim 1, further comprising one or more baffles disposed in the interior of the water tank.

3. The water tank of claim 2, wherein the one or more baffles are secured to one of the side panel or the back panel by welding.

4. The water tank of claim 2, wherein the one or more baffles are disposed in one or more slots formed in the side panel.

5. The water tank of claim 1, wherein the front panel is secured to the side panel via welding.

6. The water tank of claim 1, further comprising one or more accessory components or fittings secured to one or more of the side panel, the front panel or the back panel.

7. The water tank of claim 1, wherein the tank shell is formed of a plurality of fibers suspended in a thermoplastic resin.

8. The water tank of claim 7, wherein the plurality of fibers are carbon fibers or glass fibers.

9. The water tank of claim 7, wherein the thermoplastic resin is one of polyetheretherketone (PEEK), polyaryletherketone (PAEK), or polyphenylene sulfide (PPS).

10. The water tank of claim 1, further comprising a liner disposed in the interior of the water tank.

11. The water tank of claim 10, wherein the liner is a high density polyethylene (HDPE), polyetheretherketone (PEEK) or polypropylene (PP) in the form of a powder coating, film or sheet.

12. A method of forming a potable water tank, comprising:
forming a tank shell via a compression molding process, the tank shell including:
a back panel; and
a side panel extending from the back panel, the side panel defining an outer perimeter of the water tank;
separately forming a front panel by compression molding; and
securing the front panel to the side panel thereby enclosing an interior of the water tank.

13. The method of claim 12, further comprising:
forming one or more baffle sheets; and
installing the one or more baffle sheets in the interior prior to securing the front panel to the side panel.

14. The method of claim 13, wherein the one or more baffle sheets are secured to one of the side panel or the back panel via welding.

15. The method of claim 13, wherein the one or more baffle sheets are installed into one or more slots formed in one of the side panel or the back panel.

16. The method of claim 12, further comprising securing the front panel is to the side panel via welding.

17. The method of claim 12, further comprising securing one or more accessory components or fittings to one or more of the side panel, the front panel or the back panel.

18. The method of claim 12, further comprising installing a liner in the interior of the water tank prior to securing the front panel to the side panel.

19. The method of claim 12, wherein the tank shell is formed of a plurality of fibers suspended in a thermoplastic resin.

20. The method of claim 12, wherein the liner is a high density polyethylene (HDPE), polyetheretherketone (PEEK) or polypropylene (PP) in the form of a powder coating, film or sheet.
